(19) United States
(12) Patent Application Publication
(10) Pub. No.: US 2015/0127397 A1
(43) Pub. Date: May 7, 2015

(54) DETERMINING SEGMENTATION AND QUEUES FOR RECOVERY OF PAYMENT FROM FINANCIAL ACCOUNTS IN ARREARS

(71) Applicant: BANK OF AMERICA CORPORATION, Charlotte, NC (US)

(72) Inventors: Hari Madala, Pittsburgh, PA (US); Michael John Blatteau, JR., Townsend, DE (US); Michael D. Fleischer, Double Oak, TX (US); Hudson Philip Hoen, IV, Wilmington, DE (US); Richard Hardin Staton, Broomall, PA (US)

(73) Assignee: BANK OF AMERICA CORPORATION, Charlotte, NC (US)

(21) Appl. No.: 14/072,523

(22) Filed: Nov. 5, 2013

(51) Int. Cl. G06Q 40/00; G06Q 10/06

(52) U.S. Cl. CPC G06Q 40/12; G06Q 10/06311
USPC 705/7.13

(57) ABSTRACT

Embodiments of the invention are directed to apparatus, methods, and computer program products for determining which segment of the enterprise financial institution to assign to payment recovery for accounts in arrears. The segment determination process applies financial institution account metrics and customer attributes to the requisite business rules to determine which segment to assign for financial account payment recovery so as to maximize profitability. In additional embodiments, work assignment queues and/or payment recovery communication channels may be determined for the accounts in arrears based on applying customer attributes and/or financial account metrics to business rules. In still further embodiments of the invention, a next-allowable-date for contacting the customer regarding an account in arrears is determined based on applying collection history data to payment recovery velocity rules which define the criteria for contacting a customer and the frequency at which a customer can be contacted.

### FIELD

In general, embodiments of the invention relate to methods, systems, apparatus and computer program products for managing the recovery of payment from financial institution account(s) in arrears and, more particularly, for determining which segment within an enterprise business should be assigned to payment recovery of an account in arrears and for determining work assignment queues that include a grouping of financial accounts in arrears.

### BACKGROUND

Financial institutions and other entities that extend credit to customers are constantly task with trying to recover payment from customers who have allowed their accounts to go past due (i.e., in arrears). Typically, such attempts at payment recovery involve contacting the customer, such as by telephone call or another form of communication, to make the customer aware that their payment on an account has gone into arrears and to encourage or seek payment on the account.

In the financial institution environment, a customer may routinely hold more than one account that requires payment, for example, a mortgage, a personal loan, a car loan, credit card(s) and the like. In such instances, if a customer is experiencing difficulty in making timely payments to one of the accounts it is likely that they may also be experiencing difficulty making payment on other, if not all, accounts. Traditionally, in large enterprise financial institutions in which products, such as mortgages, loans and credit cards and the like, are compartmentalized by business lines/units, each business line/unit, having their own systems of record and recovery processes, would be responsible for recovering payment on accounts in arrears. From a customer perspective, if the customer is in arrears on more than one account held at the financial institution, the customer can expect to be contacted individually by each business line/unit seeking payment recovery.

From the enterprise financial institution perspective, having such numerous diverse systems for payment recovery is inefficient, in that, numerous associates/representatives are tasked with contacting customers who have accounts in arrears. As such, a customer with multiple accounts in arrears may be inundated with concurrent telephone calls, emails or other forms of communication by different business units/line-of-business with the financial institution. However, as detailed herein, a unified payment recovery system that seeks to recover payment for all accounts and/or financial products existing throughout an enterprise financial institution also poses some problems. For example, since the unified recovery system attempts to recover across multiple accounts and products a decision must be made as to which business unit/line-of-business or the like (collectively referred to herein as a “segment”) should currently be responsible for attempting to collect payment from a customer and, especially, those customers with multiple accounts in arrears, such accounts associated with different business units/line-of-business within the financial institution. Moreover, the outcome of such a decision constantly changes as the needs of the financial institution change and the payment status of the customer changes. In addition, decisions must be made as to how to group accounts in arrears in terms of work assignments (referred to herein as work assignment queues), so as to maximize the effectiveness of the payment recovery process.

Therefore, a need exists for a comprehensive and unified financial institution account payment recovery system that properly and automatically determines, on an on-going basis, which segment of the enterprise financial institution to assign to payment recovery for accounts in arrears. The segment determination process should apply the requisite business rules so as to maximize profitability in terms of payment recovery. In addition, a need exists within such a system to determine, on an on-going basis, work assignment queues for the accounts in arrears. The work assignment queue determinations should group the accounts based on similar attributes of the customers, the accounts and/or business rules. Additionally, a need exists to determine, on an on-going basis, which communication channel (e.g., live telephone call, automated voice mail telephone call, email, text or the like) should be used to contact the customer and determine, on an on-going basis, an appropriate time for contacting a customer regarding an account in arrears based on velocity rules which define the frequency at which a customer can be contacted.

### BRIEF SUMMARY

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention relate to systems, apparatus, methods, and computer program products for a comprehensive and unified financial institution account payment recovery system that properly and automatically determines, on an on-going basis such as daily or the like, which segment of the enterprise financial institution to assign to payment recovery for accounts in arrears. The segment determination process applies financial institution account metrics and customer attributes to the requisite business rules to determine which segment to assign for financial account payment recovery so as to maximize profitability. In additional embodiments, systems, apparatus and methods provide for determining, on an on-going basis such as daily or the like, work assignment queues for the accounts in arrears. The work assignment queue determinations group the accounts for the purpose of representative/associate work assignments based on applying customer attributes and/or financial account metrics to business rules.

Further embodiments of the invention relate to systems, apparatus, method, and computer program products that provide for determining, on an on-going basis, which communication channel (e.g., live telephone call, automated telephone call, email, text or the like) should be used to contact the customer by applying account metrics and/or customer attributes to the requisite business rules and determining, on an on-going basis, an appropriate time (i.e., a next-allowable-date for contacting a customer regarding an account in arrears based on applying collection history data to payment recovery velocity rules which define the criteria for contacting a customer and the frequency at which a customer can be contacted.

An apparatus for managing financial account payment recovery in an enterprise business defines first embodiments of the invention. The apparatus includes a computing platform having a memory and at least one processor in communication with the memory. The apparatus further includes a payment recovery module that is stored in the memory and executable by the processor. The payment recovery module is configured to receive financial institution account metrics (e.g., account payment history data and account collection history data) related to a plurality of financial institution accounts, and determine, based on the financial institution account metrics, (1) a plurality of financial institution accounts currently in arrears and (2) one or more customers associated with the accounts. The payment recovery module is further configured to determine, based on applying (1) the financial institution account metrics and (2) customer attributes associated with the customers to business-defined segmentation rules, a segment of the enterprise business to assign payment recovery to for each of the plurality of financial accounts currently in arrears. In specific embodiments, the business-defined segmentation rules provide for determining the segment of the enterprise business that maximizes profitability in terms of payment recovery. In further specific embodiments, determination of the segments to assign to the financial accounts occurs on a daily-basis prior to a business day.

In further embodiments of the apparatus the payment recovery module is further configured to determine based on applying (1) the financial institution account metrics and (2) the customer attributes to business-defined queuing rules, a plurality of work assignment queues, wherein the work assignment queue includes a grouping of a plurality of the financial accounts currently in arrears. In specific embodiments of the apparatus, the payment recovery module is further configured to determine the work assignment queues in response to determining the segment of the enterprise business responsible for attempting payment recovery for each of the plurality of financial accounts currently in arrears. In specific embodiments of the invention, the determination of the work assignment queues occurs on a daily basis prior to a business day.

In other specific embodiments of the apparatus, the payment recovery module is further configured to determine, based on applying the (1) financial institution account metrics and (2) the customer attributes to business-defined payment recovery channel rules, a payment recovery channel for attempting payment recovery for each of the plurality of financial accounts currently in arrears. The payment recovery channel defines the communication channel (e.g., live telephone call, automated telephone call, email, text, and the like) that is to be used to contact the customer regarding payment recovery.

In still further specific embodiments of the apparatus, the payment recovery module is further configured to determine, based on applying account collection history data to payment recovery velocity rules, a next allowable date for attempting payment recovery from each of the financial accounts currently in arrears.

A method for payment recovery in an enterprise business defines second embodiments of the invention, the method includes receiving financial institution account metrics (e.g., account payment history data and account collection history data) related to a plurality of financial institution accounts and determining based on the financial institution account metrics, (1) a plurality of financial institution accounts currently in arrears and (2) one or more customers associated with the accounts. The method further includes determining, based on applying (1) the financial institution account metrics and (2) customer attributes associated with the customers to business-defined segmentation rules, a segment of the enterprise business to assign payment recovery to for each of the plurality of financial accounts currently in arrears. In specific embodiments of the method, determining the segment of the enterprise business that maximizes profitability in terms of payment recovery. In still further specific embodiments of the method determining the segment occurs on a daily-basis prior to a business day.

In specific embodiments the method further includes determining, based on applying (1) the financial institution account metrics and (2) the customer attributes to business-defined queuing rules, a plurality of work assignment queues, wherein the work assignment queue includes a grouping of a plurality of the financial accounts currently in arrears. In specific embodiments of the method determining the work assignment queues occurs in response to determining the segment of the enterprise business responsible for attempting payment recovery for each of the plurality of financial accounts currently in arrears. In other specific embodiments of the method, determining the work assignment queues occurs on a daily-basis prior to a business day.

In still further specific embodiments the method includes determining based on applying the (1) financial institution account metrics and (2) the customer attributes to business-defined payment recovery channel rules, a payment recovery channel for attempting payment recovery for each of the plurality of financial accounts currently in arrears.

Moreover, in other specific embodiments the method includes determining, based on applying the account collection history data to payment recovery velocity rules, a next allowable date for attempting payment recovery from each of the financial accounts currently in arrears.

A computer program product that includes a non-transitory computer-readable medium defines third embodiments of the invention. The computer-readable medium includes a first set of codes for causing a computer to receive financial institution account metrics related to a plurality of financial institution accounts. The computer readable-medium additionally includes a second set of codes for causing a computer to determine, based on the financial institution account metrics, (1) a plurality of financial institution accounts currently in arrears and (2) one or more customers associated with the accounts. In addition, the computer-readable medium includes a third set of codes for causing a computer to determine based on applying (1) the financial institution account metrics and (2) customer attributes associated with the customers to business-defined segmentation rules, a segment of the enterprise business to assign payment recovery to for each of the plurality of financial accounts currently in arrears. In specific embodiments of the computer program product, the computer-readable medium includes a fourth set of codes for causing a computer to determine, based on applying (1) the financial institution account metrics and (2) the customer attributes to business-defined queuing rules and the determined segment, a plurality of work assignment queues, wherein the work assignment queue includes a grouping of a plurality of the financial accounts currently in arrears.

Thus, embodiments of the present invention, which are described in more detail below, provide for automatically determining which segment of the enterprise financial institution to assign to payment recovery for accounts in arrears. The segment determination process applies financial institution account metrics and customer attributes to the requisite business rules to determine which segment to assign for financial account payment recovery so as to maximize profitability. In additional embodiments, work assignment queues and/or payment recovery communication channels may be determined for the accounts in arrears based on applying customer attributes and/or financial account metrics to business rules. In still further embodiments of the invention, a next-allowable-date for contacting the customer regarding an account in arrears is determined based on applying collection history data to payment recovery velocity rules which define the criteria for contacting a customer and the frequency at which a customer can be contacted.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 is a block diagram representation of an apparatus for determining a lead account and indicating such in a unified account payment recovery system, in accordance with embodiments of the present invention;

FIG. 2 is a more detailed block diagram of an apparatus for determining a lead account and indicating such in a unified account payment recovery system, in accordance with embodiments of the present invention;

FIG. 3 is a schematic diagram of a unified recovery system environment for identifying lead accounts and indicating such on user interfaces within a unified recovery system application; in accordance with embodiments of the present invention;

FIG. 4 is a flow diagram of a method for determining a lead account and indicating such in a unified account payment recovery system, in accordance with embodiments of the present invention;

FIG. 5 provides a high level process flow illustrating the unified recovery process, in accordance with one embodiment of the present invention;

FIG. 6 provides a high level process flow illustrating the unified recovery system process, in accordance with one embodiment of the present invention;

FIG. 7 provides a unified recovery system environment, in accordance with one embodiment of the present invention;

FIG. 8 provides a process map illustrating rules implementation for the unified recovery system, in accordance with one embodiment of the present invention;

FIG. 9 provides a process map illustrating a representative use of the unified recovery system, in accordance with one embodiment of the present invention;

FIG. 10 provides an interface illustrating a representative queue, in accordance with one embodiment of the present invention;

FIG. 11 provides an interface illustrating the unified application with customer relationships, in accordance with one embodiment of the present invention;

FIG. 12 provides an expanded view of the customer information section of the unified application with customer relationships, in accordance with one embodiment of the present invention;

FIG. 13 provides an example interface illustrating a message center prior to customer communications on the unified application, in accordance with one embodiment of the present invention;

FIG. 14A provides an interface illustrating a warning message presented to the representative, in accordance with one embodiment of the present invention; and

FIG. 14B provides an interface illustrating a warning message presented to the representative, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

Furthermore, the term “product” or “account” as used herein may include any financial product, service, or the like that may be provided to a customer from an entity that subsequently requires payment. A product may include an account, credit, loans, purchases, agreements, or the like between an entity and a customer. The term “relationship” as used herein may refer to any products, communications, correspondences, information, or the like associated with a customer that may be obtained by an entity while working with a customer. Customer relationship data may include, but is not limited to addresses associated with a customer, customer contact information, customer associate information, customer products, customer products in arrears, or other information associated with the customer's one or more accounts, loans, products, purchases, agreements, or contracts that a customer may have with the entity.

Although some embodiments of the invention herein are generally described as involving a “financial institution,” one of ordinary skill in the art will appreciate that other embodiments of the invention may involve other businesses that take the place of or work in conjunction with the financial institution to perform one or more of the processes or steps described herein as being performed by a financial institution. Still in other embodiments of the invention the financial institution described herein may be replaced with other types of businesses that utilized accounts in arrears recovery.

Thus, systems, apparatus, methods and computer program programs are herein described which a comprehensive and unified financial institution account payment recovery system that properly and automatically determines, on an on-going basis such as daily or the like, which segment of the enterprise financial institution to assign to payment recovery for accounts in arrears. The segment determination process applies financial institution account metrics and customer attributes to the requisite business rules to determine which segment to assign for financial account payment recovery so as to maximize profitability. In additional embodiments, systems, apparatus and methods provide for determining, on an on-going basis such as daily or the like, work assignment queues for the accounts in arrears. The work assignment queue determinations group the accounts for the purpose of representative/associate work assignments based on applying customer attributes and/or financial account metrics to business rules.

Further embodiments of the invention relate to systems, apparatus, method, and computer program products that provide for determining, on an on-going basis, which communication channel (e.g., live telephone call, automated telephone call, email, text or the like) should be used to contact the customer by applying account metrics and/or customer attributes to the requisite business rules and determining, on an on-going basis, an appropriate time (i.e., a next-allowable-date for contacting a customer regarding an account in arrears based on applying collection history data to payment recovery velocity rules which define the criteria for contacting a customer and the frequency at which a customer can be contacted.

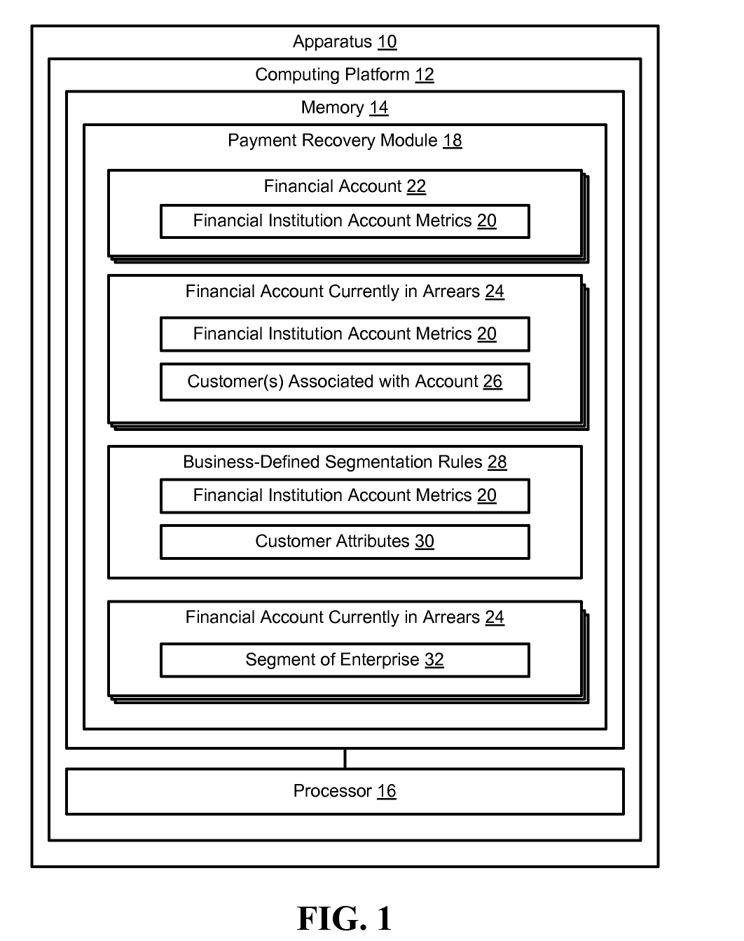

Referring to FIG. 1 a block diagram is depicted of an apparatus 10 for determining the segmentation assignment for financial accounts in arrears within a unified payment recovery system, in accordance with embodiments of the present invention. The apparatus 10, which may include more than device, includes a computing platform 12 having a memory 14 which is in communication with processor 16.

Memory 14 stores payment recovery module 18 that is included within the unified payment recovery system. The payment recovery module 18 is configured to receive financial account metrics 20 related to various financial accounts 22 from various different systems of record. The financial account metrics 20 may include, but are not limited to, data related to the current payment status of accounts, such as mortgage accounts, loan account, credit card accounts, demand deposit (e.g., checking) accounts and the like. Current payment status data may include, but is not limited to, payment balance outstanding on the account, current payment due, length of delinquency and the like. The unified nature of the payment recovery system of the present invention provides for the system to receive data feeds from most and in many embodiments all, of the systems of records within an enterprise type financial institution. The data feeds can be received on a regularly scheduled on-going basis, such as once every work day or, in other embodiments of the invention, data feeds may be received constantly on a dynamic (i.e., real time or near real time) basis and/or as-needed basis. Such regularly scheduled data feeds and/or dynamic data feeds allow for segmentation and, in some embodiments, queues to be determined on a regularly scheduled basis, such as daily, on an as needed basis or dynamically to reflect real-time or near real-time changes to financial account metrics 20 (e.g., payment made by a customer on an account having an immediate real-time effect on the lead account for that customer).

In addition, payment recovery module 18 is configured to determine, based on the financial account metrics 20, the financial accounts currently in arrears 24 and the customers 26 associated with the accounts currently in arrears. 24. In specific embodiments, the payment recovery module 18 is configured to receive account relationship data (not shown in FIG. 1 from a relationship file. The account relationship data 21 indicates which accounts are associated with a customer. Associated accounts may include those accounts held by a customer (either individually or joint) as well as those accounts which the customer is contractually or legally responsible for. Examples of accounts that are the responsibility of a customer include, but are not limited to, undersigned accounts, accounts held by a minor who is the responsibility of the customer, business accounts associated with the customer and the like. Based on the account relationship data the payment recovery module 18 is configured to implement the processor 16 to determine or identify which financial accounts currently in arrears 24 are associated with each customer 26.

Once the financial accounts currently in arrears 24 and the associated customers 26 have been determined, the payment recovery module 18 is additionally configured to implement the processor 16 to determine, based on the applying financial account metrics 20 and customer attributes 30 to business-defined segmentation rules, a segment 32 of the financial institution enterprise to assign to each of the financial accounts currently in arrears 24 for the purpose of subsequent payment recovery. A segment 32 of the financial institution may include a business unit or a line-of-business, for example, a mortgage unit, a credit/debit card unit a personal loan unit or the like. Assigning the financial account in arrears 24 to a segment 32 means that the assign segment has current responsibility for attempting to recover payment from the account in arrears 24 (i.e., contacting the customer to attempt payment recovery).

In specific embodiments of the invention, the financial account metrics may include, but are not limited to, account collection history data, payment history data, account-based payment recovery scores and the like. In other specific embodiments of the invention the business-defined segmentation rules 28 provide for determining the segments 32 of the financial institution enterprise to assign to each financial account currently in arrears 24 so as to maximize profitability in terms of payment recovery. As such, the business-defined segmentation rules that are implemented for a segmentation process may vary from day-to-day or may be written on-the-fly as the ability to maximize profitability changes due to changes in business concerns and the like. Since the financial institution account metrics 20, customer attributes 30 and segmentation rules 28 may change on a daily basis or more frequently, daily implementation of the segmentation process herein described will result in variance in the segmentation results (e.g., a financial account in arrears 24 assigned to one segment on day one may subsequently be assigned to a different segment on day two due to changes in account metrics, customer attributes and/or segmentation rules).

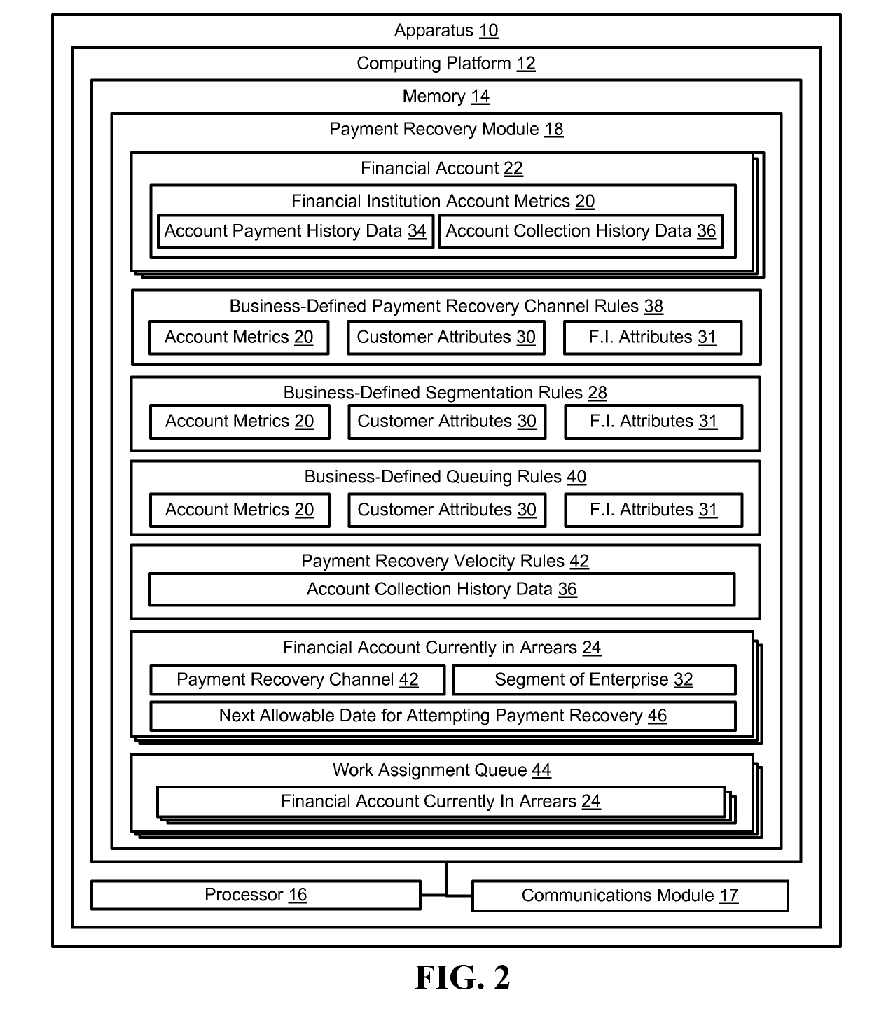

Referring to FIG. 2 shown is a more detailed block diagram of apparatus 10, according to embodiments of the present invention. As previously described, the apparatus 10 is configured to determine segmentation, queues, payment recovery channels and/or communication velocity in a unified account payment recovery system. In addition to providing greater detail, FIG. 2 highlights various alternate embodiments of the invention. The apparatus 10 may include one or more of any type of computerized device. The present apparatus and methods can accordingly be performed on any form or combination of computing devices, including servers, personal computing devices, laptop/portable computing devices, mobile computing devices or the like.

The apparatus 10 includes computing platform 12 that can receive and execute routines and applications. Computing platform 12 includes memory 14, which may comprise volatile and non-volatile memory, such as read-only and/or random-access memory (RAM and ROM), EPROM, EEPROM, flash cards, or any memory common to computer platforms. Further, memory 14 may include one or more flash memory cells, or may be any secondary or tertiary storage device, such as magnetic media, optical media, tape, or soft or hard disk.

Further, computing platform 12 also includes processor 16, which may be an application-specific integrated circuit (“ASIC”), or other chipset, processor, logic circuit, or other data processing device. Processor 16 or other processor such as ASIC may execute an application programming interface (“API”) (not shown in FIG. 2) that interfaces with any resident programs, such as payment recovery module 18 or the like stored in the memory 14 of the apparatus 10.

Processor 14 may include various processing subsystems (not shown in FIG. 2) embodied in hardware, firmware, software, and combinations thereof, that enable the functionality of apparatus 10 and the operability of the apparatus on a network. For example, processing subsystems allow for initiating and maintaining communications and exchanging data with other networked devices. For the disclosed aspects, processing subsystems of processor 16 may include any subsystem used in conjunction with payment recovery module 18 or subcomponents or sub-modules thereof.

Computer platform 12 additionally includes communications module 17 embodied in hardware, firmware, software, and combinations thereof, that enables communications among the various components of the apparatus 10, as well as between the other devices in the unified account payment recovery system. Thus, communication module 17 may include the requisite hardware, firmware, software and/or combinations thereof for establishing a network communication connection and initiating communication amongst networked devices.

As previously noted, the memory 16 of computing platform 12 stores payment recovery module 18 that is included within the unified payment recovery system. The payment recovery module 18 is configured to receive financial account metrics 20 associated with various financial accounts 22 from various different systems of record 40. The financial account metrics 20 may include, but are not limited to, account payment history data 34 such as payment balance outstanding on the account, current payment due, length of delinquency and the like and account collection history data 36 such as previous payment recovery collection attempts/communications, dates of attempts/communications, channels used, success of payment recovery attempts and the like.

In optional embodiments of the apparatus, the payment recovery module 18 is configured to determine, based on applying the financial account metrics 20 and/or customer attributes 30 and/or financial institution attributes 31 (i.e., financial institution-wide attributes and/or business unit/LOB-specific attributes) to business-defined payment recovery channel rules 38, a payment recovery channel 42 for each financial account currently in arrears 24 and/or each customer associated with a financial account currently in arrears 24. The payment recovery channel 42 may include, but is not limited to, a “live” associate/representative telephone call, an automated recorded telephone call, an electronic mail, a text message or the like. Account collection history data 36 may dictate which payment recovery channel 42 is implemented in the next subsequent payment recovery attempt. In other embodiments financial institution attributes, such as current channel resource availability may assist in determining payment recovery channel 42.

As previously discussed in reference to FIG. 1, the payment recovery module 18 is additionally configured to implement the processor 16 to determine, based on the applying financial account metrics 20 and/or customer attributes 30 and/or financial institution attributes 31 to business-defined segmentation rules 28, a segment 32 of the financial institution enterprise to assign to each of the financial accounts currently in arrears 24 for the purpose of subsequent payment recovery. A segment 32 of the financial institution may include a business unit or a line-of-business, for example, a mortgage unit, a credit/debit card unit a personal loan unit or any other portion/division of the financial institution.

In alternate embodiments of the apparatus 10, the payment recovery module 18 is configured to implement the processor 16 to determine, based on applying financial account metrics 20 and/or customer attributes 30 and/or financial institution attributes 31 to business-defined queuing rules 40, work assignment queues 44, which include a grouping of the financial accounts currently in arrears 24 that require payment recovery (i.e., contacting a customer associated with the account in arrears as a means of attempting payment recovery). Each work assignment queue 44 is subsequently assigned or accessible through the payment recovery system to one or more associates/representatives responsible for payment recovery. In specific embodiments of the invention, the work assignment queues 44 are determined in response to determining a segment 32 to assign to the financial institution account in arrears 24, such that each work assignment queue includes segment-specific financial accounts in arrears 24.

In further alternate embodiments of the apparatus, the payment recovery module 18 is configured to implement the processor 16 to determine, based on applying account collection history data 36 to payment recovery velocity rules 44, a next-allowable-date for attempting payment recovery 46 for each of the financial accounts currently in arrears 24. The velocity rules 44 define financial institution and/or government regulated rules related to the frequency at which customers can be contacted for the purpose of attempting to collect payment from accounts in arrears 24.

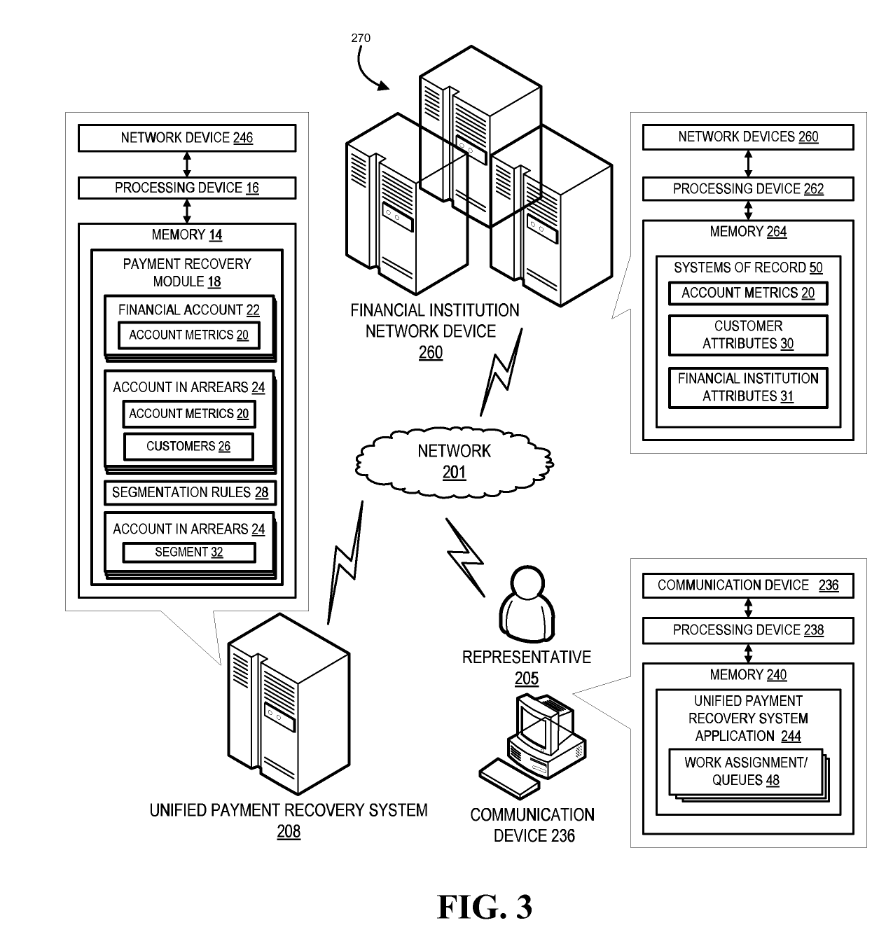

Referring to FIG. 3, a schematic diagram is shown of a system 270 for determining the segmentation and queuing in a unified payment recovery system application, in accordance with embodiments of the present invention. The system includes a plurality of financial institution network devices 260 that are in network 201 communication with a unified recovery system 208 and a plurality of associate/representative communication devices 236.

The financial institution network devices 260, which may comprise a plurality of servers and the like, include a processing device 262 that is in communication with a memory 264. The memory stores a plurality of systems of records 50. The systems of record 50 provide data feeds to the unified payment recovery system 208 in the form of financial account metrics 20 and customer attributes 30 and financial institution attributes 31 which are used to determine which accounts are in arrears 24, customers 26 associated with the accounts in arrears segmentation 32 of accounts in arrears, work assignment queues 48 and the like.

The unified recovery system 208 which resides in and is executed by one or more network devices 246 includes payment recovery module 18 which is configured to determine, based on application of financial account metrics 20, customer attributes 30 and/or financial institution attributes 31 to one or more predetermined segmentation rules 28, a segment 32 of the enterprise financial institution to assign to each financial account currently in arrears 24. In addition to determining segments 32, the payment recovery module 18 may, in some embodiments, be additionally configured to determine payment recovery channel 42 (not shown in FIG. 3), work assignment queues 48 and next-allowable-date 46 for attempting payment recovery.

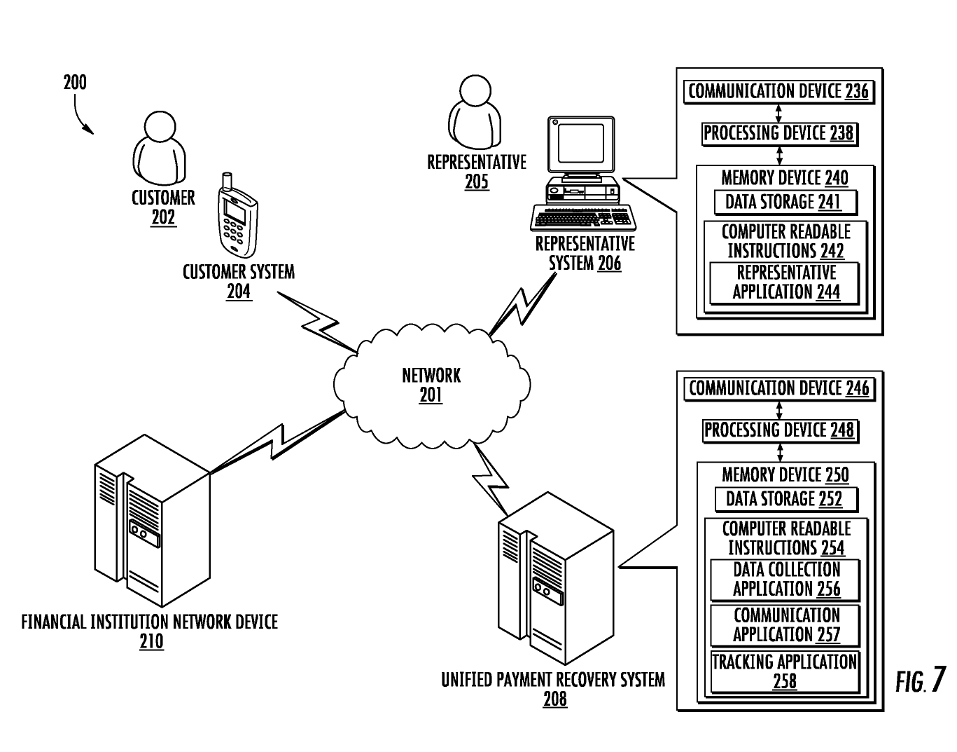

Additionally, the system 207 includes a plurality of communication devices 236, such as a personal computer (PC), laptop/portable computer or the like that is operable by financial institution representative/associate 205. The communication device stores, via memory 240 (or has network access to, a unified payment recovery system application 244, which is described in more detail in infra. in the discussion related to FIGS. 7 and 10-14. The unified payment recovery system application, which is executable by processing device 238, provides the representative 205 with unified views (i.e., user interfaces) of accounts in arrears and, specifically access to one or more work assignment queues 48 determined by payment recovery module 18.

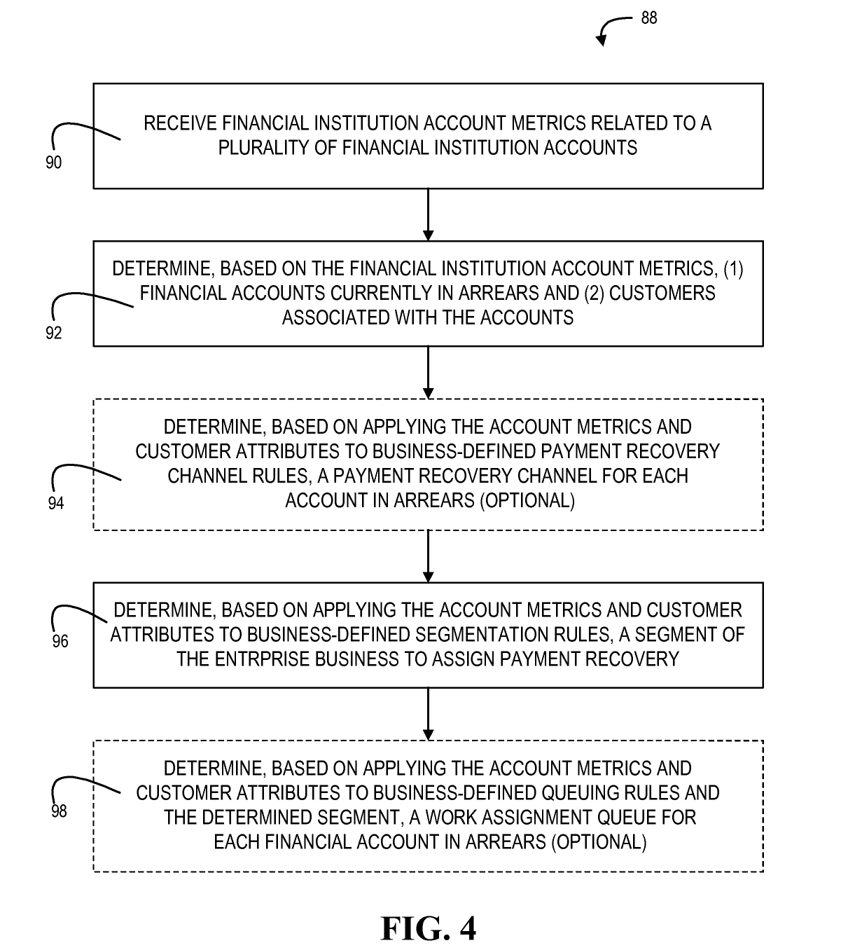

FIG. 4 is a flow diagram of a method 88 for determining segmentation of financial accounts in arrears in a unified payment recovery system, in accordance with embodiments of the present invention. At Event 90 financial account metrics related to financial institution accounts are received from a plurality of systems of record. The systems of record may include all, or at least most, of systems of record related to accounts within the financial institution which require payment. Such systems of record may include, but are not limited to, mortgage account systems of record, loan account systems of record, credit card account systems of record, Demand Deposit Account (DDA) systems of record and the like. The financial account metrics that are received may include, but are not limited to, account history data, such as account delinquencies, amounts delinquent, length of delinquency, account balance, payment due dates and the like and account collection data, such as previous payment recovery attempts, dates of payment recovery attempts, and the like. Data feeds from the systems of record may be received on an on-going scheduled basis, such as each business day, or may occur on an on-demand basis. In those embodiments in which data feeds are received on a daily basis, the account segmentation and work assignment queues may be determined on a daily basis and, thus, may change on a daily basis. In other embodiments, data feeds from the systems of record may occur in real-time (or near-real-time) as changes are made to systems of record (e.g., as payments are received from a customer and reflected in the corresponding system of record). In such embodiments, account segmentation and work assignment queues may be determined dynamically in real-time (or near-real-time).

At Event 92, based on the financial account metrics, a determination is made as to which accounts are currently in arrears and which customers are associated with the accounts in arrears. The financial account metrics are used to make a determination that one or more of the accounts are currently in arrears (i.e., a payment outstanding that is delinquent). As previously noted, based on the data feeds from the systems of record typically occurring on an on-going scheduled basis, such as once every business day, the determination of accounts in arrears may occur on the same on-going scheduled basis, such as once every business day. As previously noted, “associated” accounts include accounts held by the customer as well as accounts that are deemed to be the responsibility of the customer, such as the customer undersigning an account, a customer being legally responsible for an account or the like. In this regard, data feeds from an account relationship file may be received on an on-going scheduled basis or an as-needed on-demand basis as a means of determining which accounts currently in arrears are associated with a given customer.

At optional Event 94, based on applying the account metrics and customer attributes (and in some embodiments, financial institution attributes) to business-defined payment recovery channel rules, a payment recovery channel is determined for each account currently in arrears. The payment recovery channel is defined as the communication channel used to communicate with a customer in regards to payment recovery of one or more accounts currently in arrears. Examples of payment recovery channels may include but are not limited to “live” associate/representative telephone calls, recorded message telephone calls, text message, email message and the like. While determination of the payment recovery channel is shown in FIG. 4 as occurring prior to determination of segments and/or work assignment queues (since determination of the payment recovery channel may impact which accounts in arrears require segmentation and/or queuing), in other embodiments of the invention the determination of the payment recovery channel may occur after segmentation determination and/or work assignment queues.

At Event 96, based on applying the account metrics and customer attributes (and in some embodiments, financial institution attributes) to business-defined segmentation rules, a segment of the enterprise financial institution is assigned to each financial account in arrears. The assigned segment is the business unit/line-of-business or other division within the financial institution that is currently responsible for attempting payment recovery for the financial account in arrears. It should be noted that since the metrics and/or attributes and/or segmentation rules may change over time, the segment that is assigned to financial account in arrears may change over time, as well.

At Event 98, based on applying the account metrics and customer attributes (and in some embodiments, financial institution attributes) to business-defined queuing rules (and in some embodiments based on the determined segment), work assignment queues are determined for each financial account in arrears. Work assignment queues may be determined so as to combine financial accounts that have common characteristics/traits as they pertain to payment recovery. In specific embodiments of the invention, the work assignment queues are determined in response to segmentation determination, such that, each work assignment queue includes financial accounts in arrears that have been assigned to a specified segment of the financial institution.

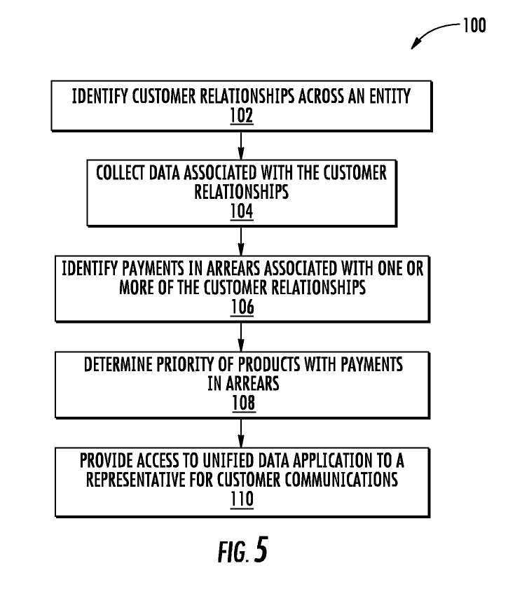

FIG. 5 illustrates a high level process flow for the unified recovery process 100, in accordance with one embodiment of the present invention, which will be discussed in further detail throughout this specification with respect to FIGS. 5-14B. As illustrated in block 102, the process 100 begins with identifying customer relationships across an entity. In this way, the system may identify all products that a customer may have with the entity across one or more lines of business within the entity. As such, addresses, affiliates, phone numbers, customer products, products with payments that are in arrears, and any other information that may be associated with a single customer may be gathered across the lines of business of an entity. Next, as illustrated in block 104, the data associated with the customer relationships may be collected and compiled in association with the customer. As such, all relationship data may be stored in association with a customer including those products and/or accounts that are in arrears.

The next step in the process 100, as illustrated in block 106, is to identify payments in arrears associated with the customer. As such, the products or accounts that have payments in arrears that are associated with that particular customer are identified. A product or account with a payment in arrears may be qualified as being in arrears based on the entity itself and/or agreements for payment between the customer and the entity. For example, after the due date for payment for the product or after a predetermined number of days after the due date, the product may be considered by the entity to be in arrears. Furthermore, the accounts or products with payments in arrears for people affiliated with that customer, such as when the customer is a guarantor for the associate or the like, may also be identified by the system. People affiliated with the customer may include friends, family, or the like associated with the customer.

As illustrated in block 108, the system determines the priority of the products with payments in arrears. In this way, the system may determine which products in arrears should take priority over the other products for purposes of recovery of payments. The primary account for recover is the account or product that the entity has identified as having payment in arrears that is the one which needs to be recovered first. This may be based on entity determination, interest rate, amount, importance, or the like. As such, the system may identify the products with payments in arrears that are the most important to recover first ahead of the other payment products. Thus, the representative may focus on recovering payments for that identified product. Finally, as illustrated in block 110, the process 100 continues by providing access to a unified application to a representative for customer communications. The unified application provides the representative with an across the entity view of the customer's relationship with the entity as well as information associated with the primary account and other accounts with payments in arrears. Finally, the unified application also provides information associated with prior customer communications. As such, the invention provides a holistic customer service experience for a customer with accounts in arrears.

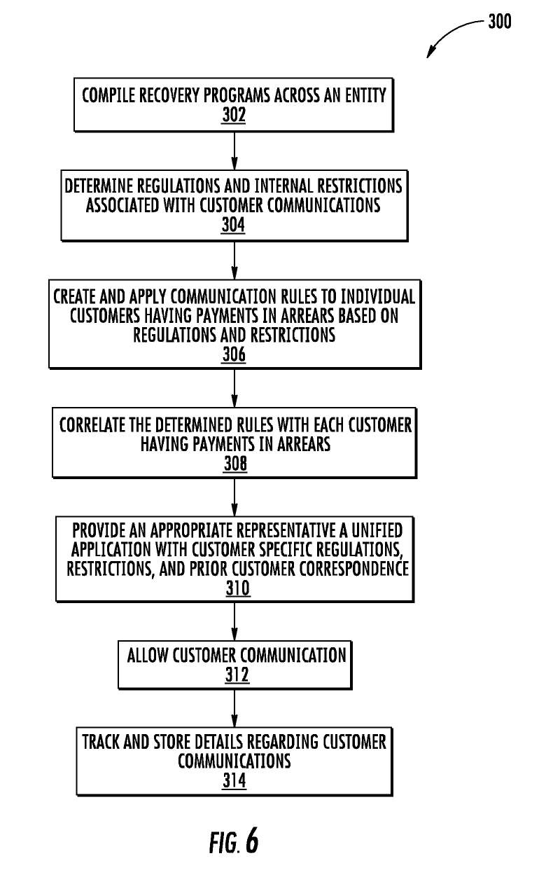

FIG. 6 illustrates a high level process flow for the unified recovery system process 300, in accordance with one embodiment of the present invention. The process 300 describes a high level of the unified recovery system's steps to providing a representative with the unified application to aid in payment in arrears recovery. First, as illustrated in block 302, the system compiles the various recovery programs across the entity. In this way, all recovery programs may be centralized, such that the representative can log into a single system. This eliminates requiring the representative to log into a plurality of software programs in order to view and understand all relationships a customer has with the entity.

Next, as illustrated in block 304, the system may determine regulations and internal restrictions associated with individual customer communications. Regulations may include laws or other regulations regarding the time of day a customer may be contacted, the amount of times within a given day/week/month that a customer may be contacted, a telephone number in which a customer may be contacted, or the like. As such, the system ensures that the representative is following all regulations and/or laws regarding the contacting of customers with products having payments in arrears. Internal regulations may include any rule that an entity may put in place to restrict or warn a representative prior to the representative contacting a customer or during the representative's communication with the customer. For example, an internal regulation may be set based on a customer communication preference, such as a specific telephone number to utilize for communications with the customer. In another example, the entity may identify an event that requires the entity to delay in communicating with a customer regarding a product with a payment in arrears (e.g., a natural disaster in the geographic are where the customer is located or another known event that may interfere with a customer providing payment).

In some embodiments, the regulations or restrictions may, in some instances, be overridden by the representative. In this way, the representative may still contact the customer even if a regulation or restriction is in place. The representative may need to input a reason for overriding the regulation or restriction. In some embodiments, the regulation or restriction may not be overridden by any representative. In this way, the system will not allow the representative to communicate with the customer at that time. In some embodiments, no regulation or restriction may be placed on a customer communication. As such, the representative may contact the customer at any time.

Next, as illustrated in block 306 the system may utilize the regulations and restrictions to create rules for customer communications. These rules may be created and applied to a customer on a customer-by-customer basis. In this way, each customer, based on the customer's location, telephone number, or the like, may have a unique set of rules applied for him/her based on regulations and/or restrictions that may apply to the customer having payments in arrears for products. Next, once the rules have been created and applied in block 306, the determined rules may be correlated with each individual customer having payments in arrears, as illustrated in block 308.

As illustrated in block 310 of FIG. 6, the system may provide a unified application for displaying a customer relationship to an appropriate representative. The unified application has specific regulations, restrictions, and prior customer correspondence associated therewith. An appropriate representative may be identified by the system based on which representative has experience with that particular customer, knowledge with a particular account in arrears, or general expertise regarding a field associated with the primary account for recovery. The system may identify and match the customer with the appropriate representative based on these factors.

Next, as illustrated in block 312 the system may allow the representative to initiate a communication with the customer. Allowing the representative to initiate a communication with a customer may be based on the determined regulations and restrictions. In some embodiments, the regulations and restrictions will not allow a representative to communicate with the customer. In some embodiments, the regulations and restrictions will warn against communicating with the customer. However, a representative may be able to override the warning. In some embodiments, the regulations and restrictions will allow a representative to communicate with the customer.

Finally, as illustrated in block 314, the system may track and store details regarding the customer communications. In this way, the system may track the disposition of the communication, such as determining if a communication was answered by the customer, a busy signal was received, or that the customer answered the communication. The system may identify the date, time, means of communication (such as specific telephone number, email address, or the like). Furthermore, the system may store any comments or notes made by the representative during the communications.

FIG. 7 provides a unified recovery system environment 200, in accordance with one embodiment of the present invention. As illustrated in FIG. 7, the unified recovery system 208 is operatively coupled, via a network 201 to the customer system 204, to the representative system 206, and to the financial institution network device (or system) 210. In this configuration, the unified recovery system 208 may send information to and receive information from the customer system 204, the representative system 206, and financial institution network device (or system) 210, to correlate all of the customer's relationships with an entity into one unified recovery system. FIG. 6 illustrates only one example of an embodiment of a unified recovery system environment 200, and it will be appreciated that in other embodiments one or more of the systems, devices, or servers may be combined into a single system, device, or server, or be made up of multiple systems, devices, or servers.

The network 201 may be a global area network (GAN), such as the Internet, a wide area network (WAN), a local area network (LAN), or any other type of network or combination of networks. The network 201 may provide for wireline, wireless, or a combination wireline and wireless communication between devices on the network 201.

In some embodiments, the customer 202 is an individual who maintains products with the entity. These products may be one or more contracts, accounts, loans, transactions, agreements, or the like. As such, the customer 202 may have one or more products with payments in arrears. In some embodiments, the customer 202 may be a merchant or a person, employee, agent, independent contractor, and the like acting on behalf of the merchant that may have one or more products with payments in arrears with the entity.

As illustrated in FIG. 7, the unified recovery system 208 generally comprises a communication device 246, a processing device 248, and a memory device 250. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 248 is operatively coupled to the communication device 246 and the memory device 250. The processing device 248 uses the communication device 246 to communicate with the network 201 and other devices on the network 201, such as, but not limited to the representative system 206, the customer system 204, and the financial institution network device (or system) 210. As such, the communication device 246 generally comprises a modem, server, or other device for communicating with other devices on the network 201.

As further illustrated in FIG. 7, the unified recovery system 208 comprises computer-readable instructions 254 stored in the memory device 250, which in one embodiment includes the computer-readable instructions 254 of a data collection application 256. In some embodiments, the computer-readable instructions 254 include a communication application 257. In some embodiments, the computer-readable instructions 254 include a tracking application 258. In some embodiments, the memory device 250 includes data storage 252 for storing data related to unified recovery system including but not limited to data created and/or used by the data collection application 256, communication application 257, and/or tracking application 258.

In the embodiment illustrated in FIG. 7 and described throughout much of this specification, the data collection application 256 may be configured to collect and compile recovery programs utilized across the entity, customer relationship data across an entity, and to generate a centralized location for customer data.

In some embodiments, the data collection application 256 may collect and compile recovery products utilized across the entity into a single centralized unified recovery system 208. These may be collected from entity representative systems 206, the financial institution network device (or system) 210, and/or other systems. These recovery products may be internal or external dockets, ledgers, software, systems, or the like that are designed to initiate, monitor, and record any communication or payment associated with customer 202 product accounts in arrears.

In some embodiments, the data collection application 256 may collect and compile customer relationship data. In this way, the data collection application 256 may compile all information that an entity may have associated with a customer 202. Customer relationship data may include, but is not limited to addresses associated with a customer, customer contact information, customer affiliate information, customer products, customer products in arrears, or other information associated with the customer's one or more accounts, loans, products, purchases, agreements, or contracts that a customer may have with the entity. In some embodiments, the customer relationship associates primary, secondary, and relationship accounts and/or products with various customers to one customer. In this way, some accounts associated with a family member, friend, or that customer may all be associated with that customer. This way, the data collection application 256 compiles this data such that one individual customer may be contacted regarding one or more accounts/products in arrears. Customer affiliates may be one or more of co-signers, named on the account, family member, or the like associated with the account.

In other embodiments, the data collection application 256 may merge the recovery programs and the customer relationship data together into the unified recovery system 208. This data may be stored and grouped by the customer 202, customer identification number, account number, or telephone number. In this way, the system may generate a single centralized location for customer relationships for a representative to view and interact with. As such, any different recovery products and customer relationship data may be integrated into the one centralized unified recovery system.

In the embodiment illustrated in FIG. 7 the unified recovery system 208 further comprises a communication application 257. The communication application 257 allows for presentment of data to the representative, for rules determination and presentment, determines primary accounts for recovery, and for communication via a network 201 with the customer 202.

In some embodiments, the communication application 257 allows for presentment of data to the representative. This data may be customer 202 information, prior communications, communication dispositions, current accounts, accounts in arrears, primary accounts for recovery, and the like. In this way, the representative may have information associated with all customer relationships within the entity easily accessible for his/her communication with the customer 202.

In some embodiments, the communication application 257 allows for incorporation of a rules engine into the information provided to the representative. In some embodiments, the rules associated with the rules engine may be manually input by a representative. In some embodiments, the rules associated with the rules engine may be automatically input. In some embodiments, the rules may be based on entity requirements or preferences. In this way, the rules may be based on segments of the entity, such as lines of business, business units, or the like. In some embodiments, the rules may be based on customer preferences. In yet other embodiments, the rules may be based on legal requirements or restrictions. These rules may be communicated to the representative system 206 for the representative 205 from the communication application 257 via the network 201. In this way, the representative 205 may be aware of the rules for customer 202 communications.

Along with the rules, the communication application 257 may also determine a primary accounts for recovery associated with the customer 202, identify an appropriate representative 206, warn or prohibit communications to a customer 202, or require disposition input after a communication. Determining a primary account for recovery requires the communication application 257 to communicate with the financial institution network device (or system) 210 to select an account in arrears that is the primary account for the entity to focus recovery efforts. This may be determined by entity determined factors, such as interest rates, amounts due for recovery for one or more accounts in arrears, representative determined accounts, mortgage accounts, or the like. Selecting an appropriate representative may be achieved by the communication application 257 based on which representative has experience with that particular customer, knowledge with that particular primary account for recovery, or general expertise regarding a field associated with the primary account for recovery. The communication application 257 may communicate warning or prohibiting communications to a customer 202 via the network 201 to a representative system 206.

In some embodiments, the communication application 257 may allow for communications between a representative 205 of the entity and a customer 202 of the entity via the network 201. In preferred embodiments, the communication between the representative 205 and the customer 202 is typically done through telephone communications, such as telephone calls. Other representative 205 communication with the customer 202 may be via text messaging, email messaging, or other voice communications. In this way, the communication application 257 allows for the communication, limits the communication, and/or doesn't allow any communication based on the rules determined.

In the embodiment illustrated in FIG. 7 the unified recovery system 208 further comprises a tracking application 258. The tracking application 258 tracks the customer 202 communications. As such, dates, times, outcomes, responses, dispositions, or the like associated with each and every attempt to contact the customer 202 is tracked and recorded. In this way, the system may track whether a communication went through to the customer, whom the representative spoke to, the duration of the communication, time of communication, date of communication, or the like.

As illustrated in FIG. 7, a representative 205 may be an individual customer service representative for an entity. In some embodiments the representative 205 may be an individual employed by the entity. In some embodiments, the representative 205 may be an outside contractor for the entity. The representative 205 may have unique skills or experience with recovery payments in arrears for various products associated with products provided by the entity.

As illustrated in FIG. 7, the representative system 206 generally comprises a communication device 236, a processing device 238, and a memory device 240. The processing device 238 is operatively coupled to the communication device 236 and the memory device 240. In some embodiments, the processing device 238 may send or receive data from the customer system 204, financial institution network device (or system) 210, and/or the unified recovery system 208 via the communication device 236 over a network 201. As such, the communication device 236 generally comprises a modem, server, or other device for communicating with other devices on the network 201.

As further illustrated in FIG. 7, the representative system 206 comprises computer-readable instructions 242 stored in the memory device 240, which in one embodiment includes the computer-readable instructions 242 of a representative application 244.

In the embodiment illustrated in FIG. 7, the representative application 244 allows the representative system 206 to be linked to the unified recovery system 208 to communicate, via a network 201, the information related to the communications with a customer 202 related to products with payments in arrears. In some embodiments, the communication from the representative 205, such as communication inputted on the unified application by the representative 205, may be communicated to the unified recovery system 208 via the communication device 236. The representative application 244 may also allow the representative to receive data, such as the unified application including customer relationships, or the like, in order to communicate with the customer.

FIG. 7 also illustrates a customer system 204. The customer system 204 generally comprises systems with devices the same or similar to the devices described for the unified recovery system 208, and/or the representative system 206 (i.e., communication device, processing device, and memory device). Therefore, the customer system 204 may communicate with the unified recovery system 208, the representative system 206, and/or the financial institution network device (or system) 210 in the same or similar way as previously described with respect to each system. The customer system 204, in some embodiments, is comprised of systems and devices that allow the customer 202 to communicate with the representative 205 over a network 201. The customer system 204 may be, for example, a home phone, a desktop personal computer, a mobile system, such as a cellular phone, smart phone, personal data assistant (PDA), laptop, or the like. Although only a single customer system 204 is depicted in FIG. 7, the unified recovery system environment 200 may contain numerous customer systems 204.

The financial institution network device (or system) 210 is operatively coupled to the unified recovery system 208, the representative system 206, and/or the customer system 204 through the network 201. The financial institution network device (or system) 210 has systems with devices the same or similar to the devices described for the unified recovery system 208 and the representative system 206 (i.e., communication device, processing device, and memory device). Therefore, the financial institution network device (or system) 210 communicate with the unified recovery system 208, the representative system 206, and/or the customer system 204 in the same or similar way as previously described with respect to each system. The financial institution network device (or system) 210, in some embodiments, is comprised of systems and devices that allow the unified recovery system 208, the representative system 206, and the customer system 204 to access one or more accounts associated with the customer 202 of the financial institution.

It is understood that the servers, systems, and devices described herein illustrate one embodiment of the invention. It is further understood that one or more of the servers, systems, and devices can be combined in other embodiments and still function in the same or similar way as the embodiments described herein.

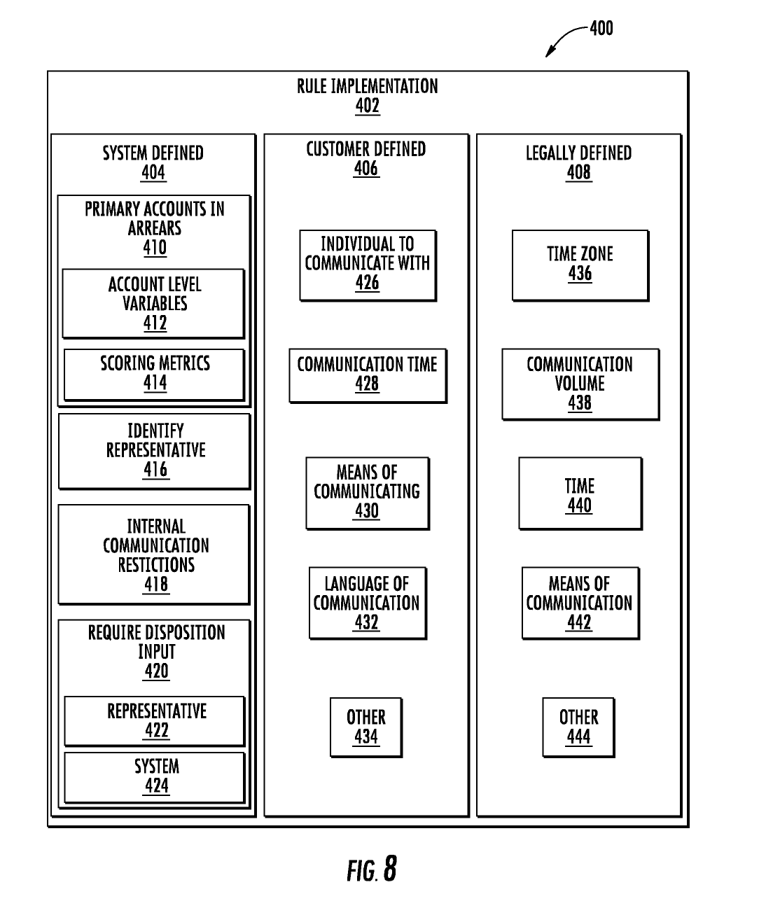

FIG. 8 illustrates rules implementation for the unified recovery system 400, in accordance with one embodiment of the present invention. The rules for rule implementation 402 may be developed by different sources. As such, there may be rules that are system defined 404, customer defined 406, or legally defined 408.

System defined 404 rules for implementation include determining a primary account or product in arrears for recovery 410, identifying an appropriate representative 416, internal communication restrictions 418, and requiring the providing of disposition inputs 420. Each of these system defined 404 rules may be implemented by the entity, one or more lines of business of the entity, or the like. The system defined 404 rules may group the customer accounts with payments in arrears in segments, queues, campaigns, lists, or the like. In this way, the system defined rules 404 may group customer accounts with payments in arrears that are similar to each other, such that they may be grouped together and placed into a single representative's segment, queue, campaign, list, or the like.

Determining the primary account for recover requires the system to determine the priority of the products with payments in arrears that should be collected ahead of other products, such receiving payments on a home loan owned by the customer ahead of payments on a car loan and credit card also associated with customer. In this way, the system may determine which products in arrears require recovery first. This is referred to as the primary account for recovery. The primary account for recovery is the account or product that the entity has identified as having the highest priority for recovery of payments over the other accounts held by the customer. In specific embodiments, the primary account for recovery 410 is based on account level variables 412 and/or internal scoring metrics 414. The account level variables 412 include account information such as interest rate, amount in arrears, or the like. Internal scoring metrics 414 measure the various products provided by an entity to determine which are the most important to recover. These may include various types of loans, lines of credits, or the like. As such, the entity will internally determine the importance of recovering each of these products. As such, the system may identify the account/product with payments in arrears to be recovered first, over all other accounts in arrears (i.e., the product that all recovery efforts must be focused on initially. This account is classified as the primary or lead account in arrears for recovery 410.

In some embodiments, the system defined 404 rules include identifying an appropriate representative 416. Identifying an appropriate representative 416 based on rules requires determining which representative has experience with that particular customer, knowledge with that particular primary account for recovery, or general expertise regarding a field associated with the primary account for recovery.

In some embodiments, the system defined 404 rules include internal communication restrictions 418. These rules may place a restriction or warning on the attempted communication with a customer. The internal communication restrictions 418 may be provided by the system based on various factors associated with that customer or customer location. For example, the system may determine that there has been a natural disaster such as a hurricane, flood, tornado, earthquake or the like near the customer's location. As such, the system may restrict communications with that customer. Internal communication restrictions 418 may also be any other internally documented or noted reason for delaying or restricting the communications with a customer.

In some embodiments, the system defined 404 rules include rules requiring dispositions to be inputted 420. Dispositions may be narratives from the representative 422 or system 424 that detail the customer communications. Representative 422 disposition input may include information about the customer communication, such as if an agreement was reached on payment, updated information about the customer, or information about the discussion between the representative and the customer. System 424 disposition input may include system identified data regarding the customer communication. This may include the time of day for the communication, date of communication, whether the customer answered, whether a third party answered, whether the communication line was busy, whether there was no answer, or the like.

Customer defined 406 rules for implementation include which individual(s) to communicate with 426, an approved communication time 428, an approved means of communicating 430, a language of communication 432, or other 434. In some embodiments, the customer defined 406 rules include individuals to communicate with 426. In this way, a customer may identify a guarantor or individual within the household that may be responsible for the product in arrears. As such, the customer may note which individual to have communications with to discuss payments for the product in arrears.

In some embodiments, customer defined 406 rules include best communication times 428. In this way, the customer may state that the best time to reach or communicate with him/her is a specific time. For example, a customer may request the representative communication at 8:00 pm to discuss the product with payments in arrears. As such, the communication time customer defined 406 rule may be to communicate with the customer at the time the customer has specified.

In some embodiments, the customer defined 406 rules may include restrictions on the means of communication 430. The means of communication 430 may include telephone communications, other voice communications, email communication, text communications, or the like. The customer may recommend that he/she be communicated with strictly by one or more of the communication means. This request will be implemented as a rule for the representative to be made aware of prior to customer communications.

In some embodiments, the customer defined 406 rules may include a language of communication 432. In this way, various languages such as Spanish, French, German, or the like may be spoken with that particular customer. Finally, customer defined 406 rules may change based on the customer. As such, other rules may be added or removed based on customer preference. Thus, providing the customer with a more pleasant communication regarding products with payments in arrears.

Legally-defined 408 rules for implementation include rules based on any laws or regulations that are directed towards a representative communication with a customer regarding payments in arrears for products. These legally defined 408 regulations or restrictions may include laws or other regulations regarding the time zone 436 of the customer. The time zone 436 associated with the customer may be identified based on the area code of the customer's telephone number. In some embodiments, there may be more than one time zone associated with the customer. Each time zone 436 rule will be stored individually per telephone number or communications means. There may be legal restrictions associated with when a customer may be contacted based on the time of day because of a difference in time zones between the customer and the representative.

In some embodiments, the legally defined 408 rules may restrict the communication volume 438, otherwise referred to as communication velocity. The communication volume 438 may be the amount of times the representative may contact the customer within a predetermined time period, such as number of times in a day/week/month. Furthermore the communication volume 438 may include the duration of time that the representative may spend in communication with a customer within a predetermined time period, such a limited amount of time in a 24 hour period.

In some embodiments, the legally defined 408 rules may restrict the time 440 of day the customer may be contacted. For example, a customer may only be contacted between 9:00 am and 6:00 pm during the week and not at all during the weekend. As such, the time 440 restrictions will utilize the time zone of the area code and determine if it is acceptable to communicate with the customer at that time. The system may be configured to forbid calling the customer outside of the acceptable time period.

In some embodiments, the legally-defined 408 rules may include restrictions on the means of communication 442. The means of communication 442 may include telephone communications, other voice communications, email communication, text communications, or the like.

In some embodiments, the rules may, in some instances, be over rode by the representative. In this way, the representative may still contact the customer even if a rule restricting the communication may be in place. The representative may need to input a reason for overriding the rule. In some embodiments, the rule may be permanent or unchangeable, thus a representative may not ever be capable of override the rule. In this way, the system will not allow the representative to communicate with the customer at that time. In some embodiments, no rule may be placed on a customer communication. As such, the representative may contact the customer at any time.

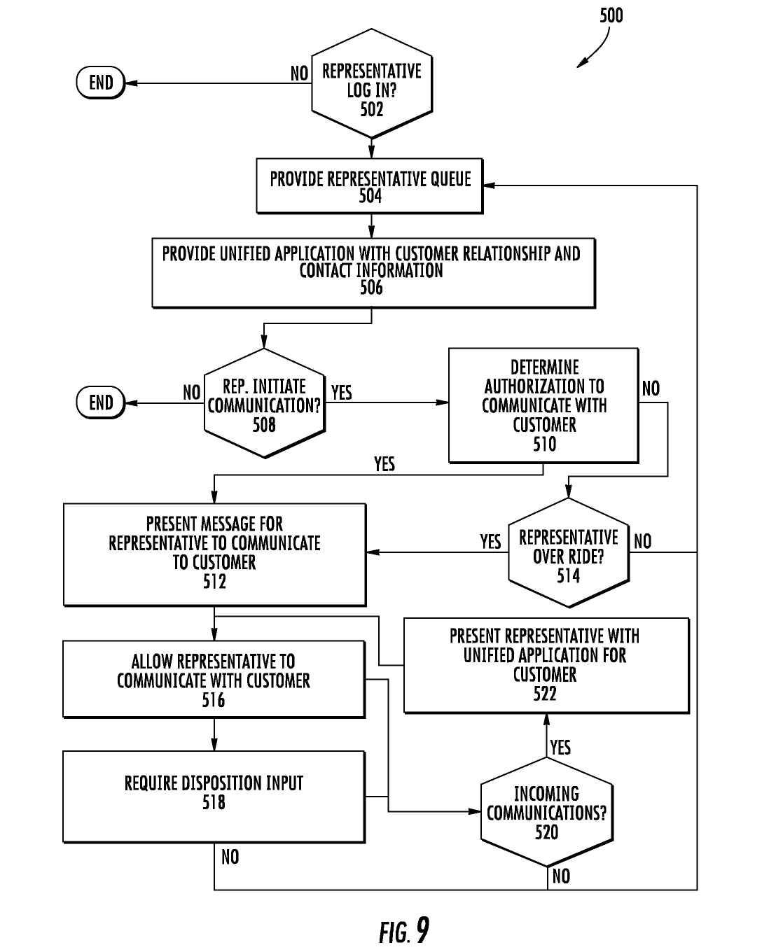

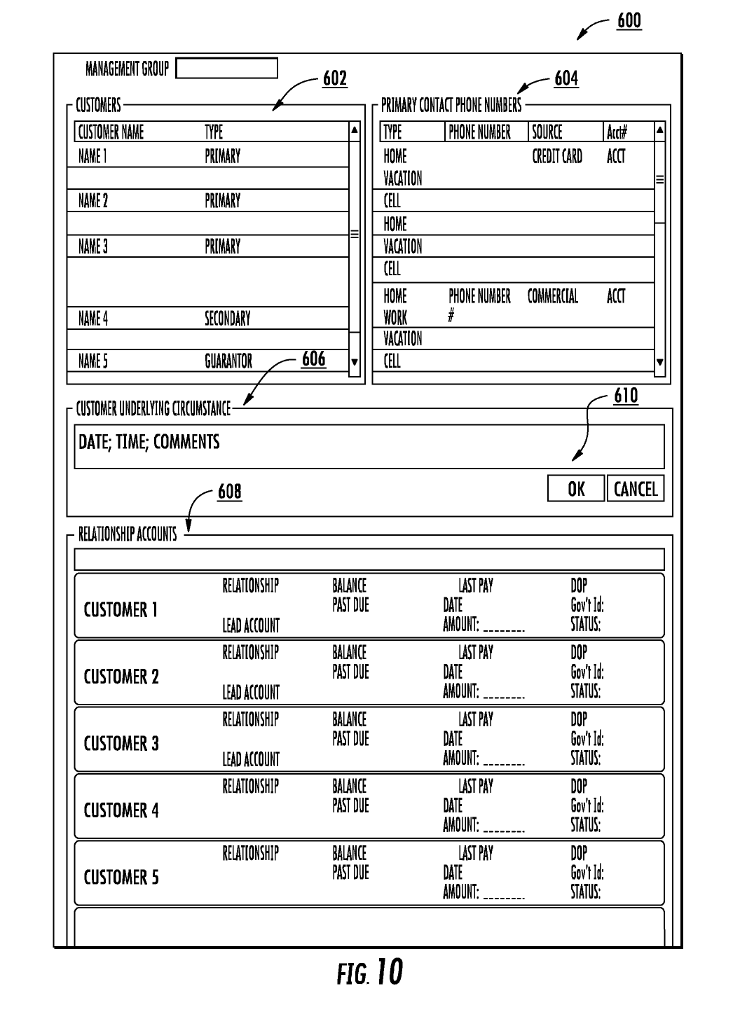

FIG. 9 illustrates a process map for a representative use of the unified recovery system 500, in accordance with one embodiment of the present invention. As illustrated in decision block 502 the process 500 is initiated when a representative logs on to the system. If the representative does not log on to the system, the process 500 is terminated. If the representative successfully logs on to system. Next, the system provides the representative queue to the representative, as illustrated in block 504. The representative queue provides a list of one or more customer's that the representative may communicate with in a day. The queue may be tailored to the representative, such that the queue is unique based on the representative's experience or the like. The queue provided in block 504 is illustrated in further detail below in FIG. 10.

FIG. 10 provides an interface illustrating a representative queue 600, in accordance with one embodiment of the present invention. As illustrated in section 602 the customers within the representative's queue are listed. Specifically, the customer's name and status type associated with the product with payments in arrears. In this example, the customers are primary, secondary, and a guarantor of the products with payments in arrears. Next, as illustrated in section 604 the primary contact phone numbers and other contact information is displayed. As such, the customer in the customer section 602 may be different than the primary contact's information in section 604. Along with the primary contact's telephone number and contact information, the source of the product with payments in arrears is displayed as well as the account number associated therewith. As illustrated in block 606 customer circumstance, including rules or comments regarding prior communications may be displayed for quick reference prior to the representative selecting the customer and entering the interface associated with the customer unified application. The representative may add or subtract further comments in the customer circumstance section 606 by selecting the ok or cancel buttons 610. Finally, as illustrated in section 608, the relationship accounts are listed. The relationship accounts correspond to the customer's within that representative's queue. This section identifies whether the account associated with the customer is a primary account, the balance due, last payment, payment schedule, and other information about the customer. In some embodiments, the customer may not be the primary contact for the account, as such this section 608 may provide the relationship the customer is to the primary contact.

Referring back to FIG. 9, as illustrated in block 506 once the representative selects a customer to communicate with from the queue the representative is provided the unified application with the customer relationship and contact information associated therewith. In some embodiments, the unified application may be presented when a representative selects a customer to contact. In other embodiments, the unified application may be presented when the representative receives an incoming communication from the customer. In yet other embodiments, the system may trigger automatic presentment of the unified application to the representative at specified time intervals.

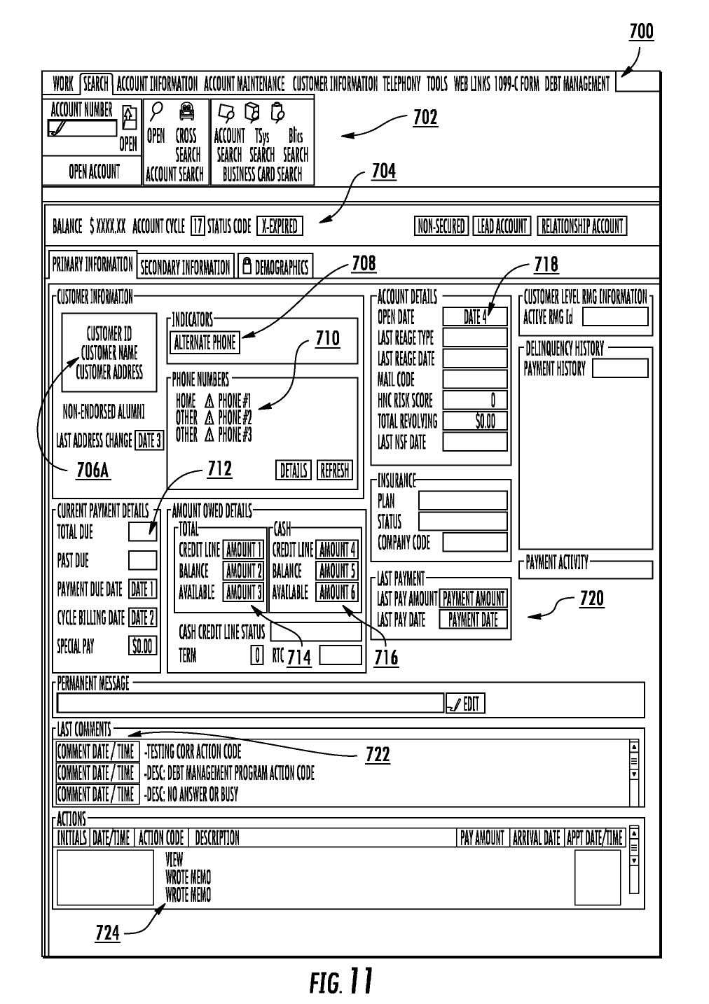

FIG. 11 illustrates an interface for the unified application with customer relationships 700, in accordance with one embodiment of the present invention. The unified application 700 presents the representative with all necessary customer relationship data, information about the products with accounts in arrears, and prior communication history in one application. The unified application 700 may display all of the customer relationships, programs, rules, and the like detailed above with respect to FIGS. 5-8. In this way, a representative may be able to provide the best possible customer service to a customer, even if this is the first time the representative has communicated with that particular customer.

As illustrated in section 702, the unified application 700 provides the representative with a general toolbar with various capabilities to search within a database, queue, or the like. The searches may be performed based on an account or product number, based on whether the unified application is open with another representative, by cross searching, or the like. As illustrated in section 704 a customer specific toolbar allows a representative to quickly determine the balance remaining on the product, the number of account cycles the product has already been through, and a status of the account. Also the representative may be provided an indication that the account is in arrears, if attempts to recover the account have been implemented, whether the account is a primary account, secondary account, or relationship account. A primary account is the account that is the account that recovery is the primary focus of first recovery. The secondary accounts are one or more accounts or products that the customer may have that also have payments in arrears, but is not the primary payment account for recovery. Relationship accounts are accounts where the customer is a guarantor or the like.

While the toolbars are provided to a representative to allow the representative to quickly discern information, more detail is provided about the customer relationship or account with payment in arrears in the subsequent sections. As illustrated in the customer information section 706A, the customer identification number, customer name, and customer address is presented to the representative. Furthermore, information, such as the last time an address was changed is also within the customer information section 706A. Below the customer information section 706A is the current payment detail section 712 where there is information presented about current payments, past payments, billing cycles, and when payments are due.

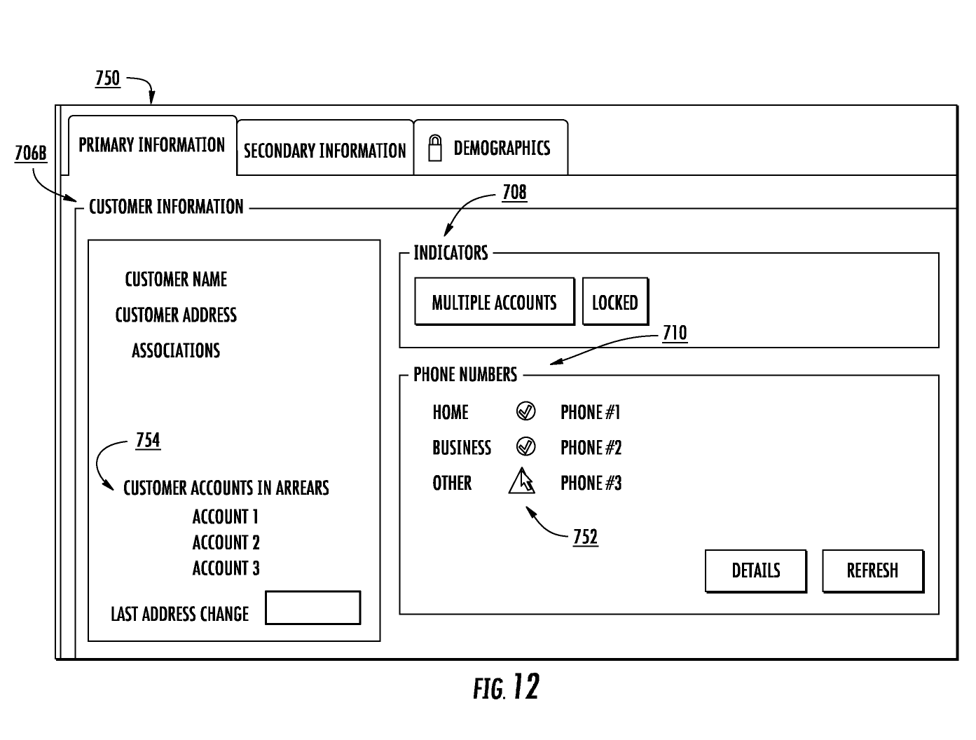

As illustrated in section 708, the system provides the representative with indicators, such as if the unified application is locked by another representative, or the like. In this example, the indicator 708 presented indicates to the representative that the alternative phone number should be used in this case. As such, the customer may have provided a customer defined rule to make all communications to an alternative telephone number. Other indicators may include blocks on accounts based on non-secured accounts, lead or primary accounts, and relationship accounts As illustrated in section 710 the communication means are presented. In this case the communication means are telephone numbers. This section allows a representative to select a telephone number to communicate with the representative. This section, along with section 708, is further detailed in FIG. 12.

Referring back to FIG. 11, the unified application 700 further provides the representative with details about amounts owed, both in total 714 and cash 716. At section 718, there are more specific details regarding the account or product with payments in arrears. As such, account details such as the open date, or the like may be presented to the representative. Furthermore, the last payment associated with that product or account may be posted in section 720. Comments from previous communications with the customer may be presented in section 722. Finally, the representative may also input actions in the action section 724. The action section 724 may also indicate other actions from other representatives associated with the customer or account. In this way, the representative will have an overview of prior comments 722 and actions 724 when a customer is speaking about prior interactions with other representatives, the representative will be knowledgeable about the communications.

Referring back to FIG. 9, once the system has provided the representative with the unified application, the representative may, in decision block 508 decide to initiate communication with the customer. If the representative does not decide to initiate communication, the process 500 is terminated. If the representative does decide to initiate communication, the communication may be initiated via the system or via an outside communication device (e.g., a desktop telephone, another computing device, or the like). Next, as illustrated in block 510, if the representative does initiate a communication in decision block 508, the system may determine if the representative is authorized to communicate with the customer 510. FIG. 12 illustrates the various indicators with respect to whether the representative may communicate with the customer at this time.

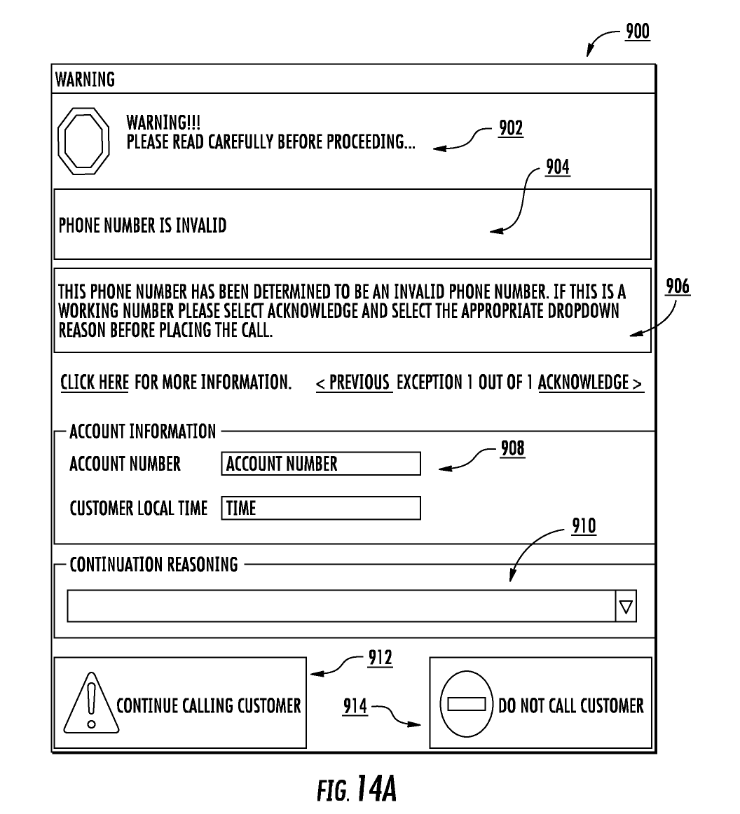

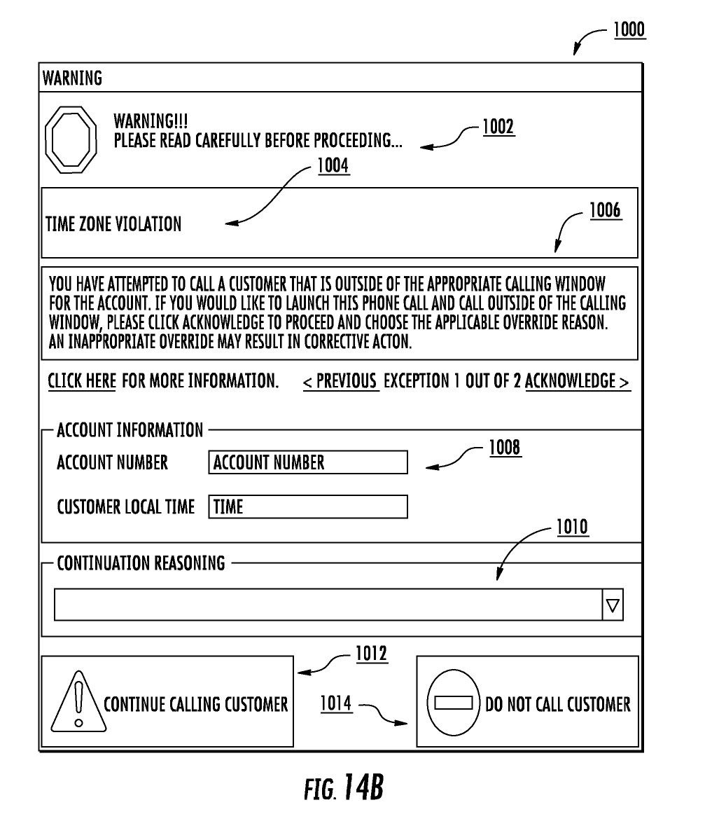

FIG. 12 illustrates an expanded view of the customer information section of the unified application 750, in accordance with one embodiment of the present invention. As described above with respect to FIG. 11, the customer information 706B provides the customer name, customer address, and in this embodiment, provides customer affiliates. Affiliates may be friends, relatives, guarantors, or the like. Furthermore, customer accounts in arrears 754 are illustrated. In this case there are three accounts in arrears listed in order of importance, from primary account down. Section 708 provides the indicators, indicating multiple accounts in arrears for this customer and that another representative has a lock on this customer unified application. In this way, a customer may have more than one account in arrears in which that customer is associated with or responsible for. A lock on the customer unified application may be because another representative is viewing the customer information, is in communication with the customer, or the like. As illustrated in section 710 the communication means for the customer are located. Here the customer has three different phone numbers that he/she may be reached. Furthermore, the communication means section 710 further comprises indicators 752 regarding the authorization of the representative to contact the customer using that contact means. These indicators 752 take into account all rules, regulations, or restrictions described above in FIG. 8. If the representative is completely restricted from contacting the customer an indicator will be provided and the representative will not be able to contact the customer. If there is a restriction but the representative may override the restriction, a warning indicator will be provided. If there are no restrictions on the communication a different indicator will be provided. For example, in the example illustrated in FIG. 12, two of the telephone numbers (Home and Business) both have a check mark indicator, indicating that the representative is free to communicate with the customer using either of the two telephone numbers. However, the other telephone number has a warning indicator, indicating that the representative may override the warning, but should have a reason to contact the customer using the other telephone number. There may be several reasons for a warning or no communications indication. If the telephone number that is selected has one of these warnings, the system will prompt the representative to a warning message, such as represented in FIGS. 14A-14B.

Referring back to FIG. 9, if the representative is not authorized to communicate with the customer in block 510 based on an indicator, the representative may decide to override the authorization if possible, as illustrated in decision block 514. If the indicator is not able to be overrode the process 500 sends the representative back to his/her queue, in block 504. FIGS. 14A and 14B illustrate a warning message presented to the representative 900, 1000, in accordance with one embodiment of the present invention. This warning message would be presented to the representative if he/she is attempting to communicate with a customer that the representative is not authorized to communicate with. The warnings provide a message to the representative regarding moving forward with the communication 902, 1002, as well as why there is a limitation on the communication with the customer. As illustrated in FIG. 14A the limitation in this case is that the telephone number is no longer valid, as illustrated in section 906. As such, the representative is not allowed to override the warning and is directed back to his/her queue. The warning also provided account information in section 908 as well as a box for the representative to input why he/she is overriding the warning in section 910. A typical override may be, for example, that the customer requested the representative call at that time/telephone number. A continuing calling customer button 912 may be highlighted if the representative is able to override the warning. If not, the representative must select the “do not call customer” button 914.

FIG. 14B provides an interface illustrating a warning message presented to the representative 1000, in accordance with one embodiment of the present invention. In this warning, the rule that is not satisfied is a legally defined rule associated with a time zone violation, as illustrated in section 1004. In section 1006 a description of the rule is presented to the representative. As illustrated in section 1008, the account information regarding the customer account associated with the customer that the representative is attempting to communicate is presented. Again, if allowed to override, the representative may input the reason for the override in section 1010. Finally, a “continuing calling customer” button 1012 may be highlighted if the representative is able to override the warning. If not, the representative must select the “do not call customer” button 1014.

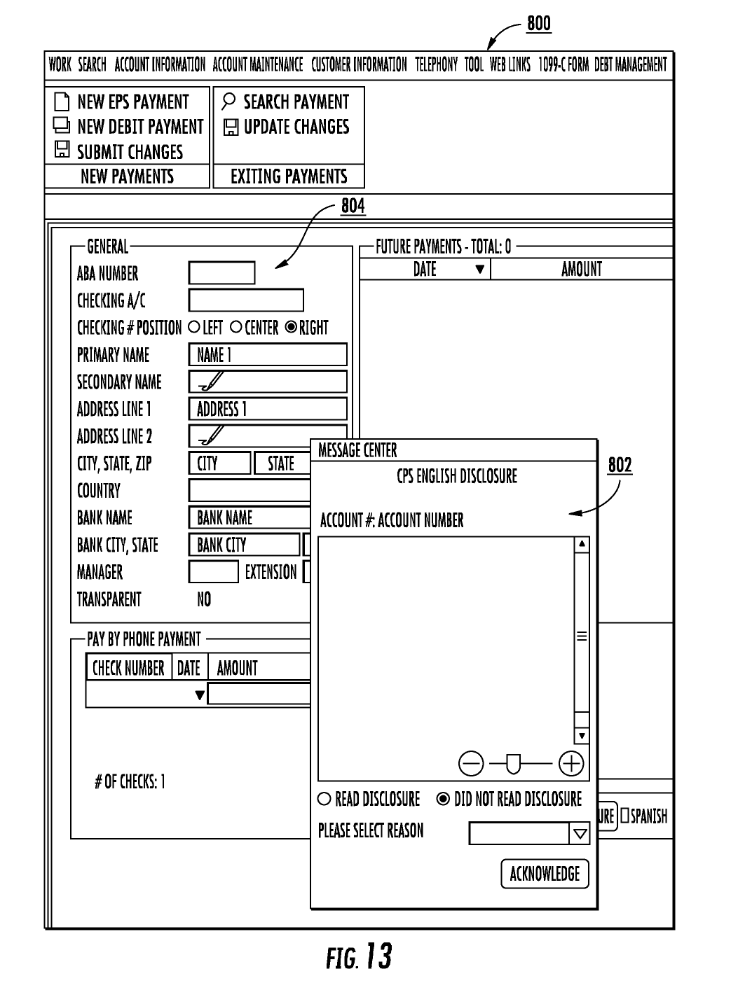

Referring again back to FIG. 9, if the representative is authorized to communicate with the customer in block 510 or the representative overrode the warning not to communicate with the customer in decision block 514, the representative may be presented with a message to communicate to the customer, as illustrated in block 512. FIG. 13 provides an example interface illustrating a message sent prior to customer communications on the unified application 800, in accordance with one embodiment of the present invention. As illustrated in section 804, general information about the customer who is being contacted is presented. At section 802 the message is presented. This message is either to be read word-for-word to the customer or generally stated to the customer. The system then requires the representative to select that he/she read the message to the customer and select the “acknowledge” button prior to continuing with the conversation.

Referring again back to FIG. 9, once the representative has read the message presented to him/her to communicate to the customer, as illustrated in block 512, the system may allow the representative to communicate with the customer about his/her products with payments in arrears, as illustrated in block 516. Next, once the communication is complete, the system may require a disposition to be inputted, as illustrated in block 518. In some embodiments, the representative must input a disposition including comments regarding the customer communication, payment, payment schedules, or the like discussed during the communication. In some embodiments, the system may input disposition data including whether the customer answered the communication, whether there was a busy signal when the representative contacted the customer, the time of the contact, the duration of the communication, and/or the date of the communication. In some embodiments, the disposition may be a payment or payment schedule from the customer to satisfy the account in arrears. In this way, a payment may be documented for the account in arrears and as such the amount of recovery may be less and/or nothing after the disposition has been made.

In certain embodiment, during the process 500, especially after the representative communication with the customer in block 516 or during the input of a disposition in block 518, the system may send the representative an incoming communication from a customer, as illustrated in decision block 520. If there is an incoming communication from a customer queued for the representative, he/she will be presented with the unified application for the customer associated with the incoming communication, as illustrated in block 522. At that point the representative may then be allowed to communicate with the customer, as illustrated in block 516. Finally, if there is no incoming communications in decision block 520, the process reverts back to providing the representative with the representative's queue, as illustrated in block 504.

Thus, the present invention as described in detail above provides for automatically determining which segment of the enterprise financial institution to assign to payment recovery for accounts in arrears. The segment determination process applies financial institution account metrics and customer attributes to the requisite business rules to determine which segment to assign for financial account payment recovery so as to maximize profitability. In additional embodiments, work assignment queues and/or payment recovery communication channels may be automatically determined for the accounts in arrears based on applying customer attributes and/or financial account metrics to business rules. In still further embodiments of the invention, a next-allowable-date for contacting the customer regarding an account in arrears is automatically determined based on applying collection history data to payment recovery velocity rules which define the criteria for contacting a customer and the frequency at which a customer can be contacted.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more general-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. An apparatus for managing financial account payment recovery in an enterprise business, the apparatus comprising:
a computing platform having a memory and at least one processor in communication with the memory; and
a payment recovery module stored in the memory, executable by the processor and configured to:
receive financial institution account metrics related to a plurality of financial institution accounts,
determine, based on the financial institution account metrics, (1) a plurality of financial institution accounts currently in arrears and (2) one or more customers associated with the accounts, and
determine, based on applying (1) the financial institution account metrics and (2) customer attributes associated with the customers to business-defined segmentation rules, a segment of the enterprise business to assign payment recovery to for each of the plurality of financial accounts currently in arrears.

2. The apparatus of claim 1, wherein the payment recovery module is further configured to determine, based on applying (1) the financial institution account metrics and (2) the customer attributes to business-defined queuing rules, a plurality of work assignment queues, wherein the work assignment queue includes a grouping of a plurality of the financial accounts currently in arrears.

3. The apparatus of claim 2, wherein the payment recovery module is further configured to determine the work assignment queues in response to determining the segment of the enterprise business responsible for attempting payment recovery for each of the plurality of financial accounts currently in arrears.

4. The apparatus of claim 1, wherein the payment recovery module is further configured to determine, based on applying the (1) financial institution account metrics and (2) the customer attributes to business-defined payment recovery channel rules, a payment recovery channel for attempting payment recovery for each of the plurality of financial accounts currently in arrears.

5. The apparatus of claim 1, wherein the payment recovery module is further configured to determine, based on applying (1) the financial institution account metrics and (2) customer attributes associated with the customers to business-defined segmentation rules, the segment, wherein the business-defined segmentation rules provide for determining the segment of the enterprise business that maximizes profitability in terms of payment recovery.

6. The apparatus of claim 1, wherein the payment recovery module is further configured to perform on a daily-basis prior to a day of business for the enterprise business, (1) receiving the financial institution account metrics, (2) determining the plurality of financial institution accounts currently in arrears and the customers associated with the accounts and (3) determining the segment of the enterprise business responsible for attempting payment recovery for each of the plurality of financial accounts currently in arrears.

7. The apparatus of claim 2, wherein the payment recovery module is further configured to perform on a daily-basis prior to a day of business for the enterprise business, (1) receiving the financial institution account metrics, (2) determining the plurality of financial institution accounts currently in arrears and the customers associated with the accounts, (3) determining the segment of the enterprise business responsible for attempting payment recovery for each of the plurality of financial accounts currently in arrears and (4) determining the plurality of work assignment queues.

8. The apparatus of claim 1, wherein the payment recovery module is further configured to receive the financial institution account metrics, wherein the account metrics include account payment history data and account collection history data.

9. The apparatus of claim 8, wherein the payment recovery module is further configured to determine, based on applying the account collection history data to payment recovery velocity rules, a next allowable date for attempting payment recovery from each of the financial accounts currently in arrears.

10. A method for payment recovery in an enterprise business, the method comprising:
receiving, by a computing device, financial institution account metrics related to a plurality of financial institution accounts;
determining, by a computing device processor, based on the financial institution account metrics, (1) a plurality of financial institution accounts currently in arrears and (2) one or more customers associated with the accounts; and
determining, by a computing device processor, based on applying (1) the financial institution account metrics and (2) customer attributes associated with the customers to business-defined segmentation rules, a segment of the enterprise business to assign payment recovery to for each of the plurality of financial accounts currently in arrears.

11. The method of claim 10, further comprising determining, by a computing device processor, based on applying (1) the financial institution account metrics and (2) the customer attributes to business-defined queuing rules, a plurality of work assignment queues, wherein the work assignment queue includes a grouping of a plurality of the financial accounts currently in arrears.

12. The method of claim 11, wherein determining the work assignment queues further comprises determining the work assignment queues in response to determining the segment of the enterprise business responsible for attempting payment recovery for each of the plurality of financial accounts currently in arrears.

13. The method of claim 10, further comprising determining, by a computing device processor, based on applying the (1) financial institution account metrics and (2) the customer attributes to business-defined payment recovery channel rules, a payment recovery channel for attempting payment recovery for each of the plurality of financial accounts currently in arrears.

14. The method of claim 10, wherein determining the segment further comprises determining, based on applying (1) the financial institution account metrics and (2) customer attributes associated with the customers to business-defined segmentation rules, the segment, wherein the business-defined segmentation rules provide for determining the segment of the enterprise business that maximizes profitability in terms of payment recovery.

15. The method of claim 10, wherein the method is performed on a daily-basis prior to a day of business for the enterprise business.

16. The method of claim 11, wherein the method is performed on a daily basis prior to a day of business for the enterprise business.

17. The method of claim 10, wherein receiving further comprises receiving, by the computing device, the financial institution account metrics, wherein the account metrics include account payment history data and account collection history data.

18. The method of claim 17, further comprising determining, by a computing device processor, based on applying the account collection history data to payment recovery velocity rules, a next allowable date for attempting payment recovery from each of the financial accounts currently in arrears.

19. A computer program product comprising:
a non-transitory computer-readable medium comprising:
a first set of codes for causing a computer to receive financial institution account metrics related to a plurality of financial institution accounts;
a second set of codes for causing a computer to determine, based on the financial institution account metrics, (1) a plurality of financial institution accounts currently in arrears and (2) one or more customers associated with the accounts; and
a third set of codes for causing a computer to determine based on applying (1) the financial institution account metrics and (2) customer attributes associated with the customers to business-defined segmentation rules, a segment of the enterprise business to assign payment recovery to for each of the plurality of financial accounts currently in arrears.

20. The computer program product of claim 19, further comprising a fourth set of codes for causing a computer to determine, based on applying (1) the financial institution account metrics and (2) the customer attributes to business-defined queuing rules, a plurality of work assignment queues, wherein the work assignment queue includes a grouping of a plurality of the financial accounts currently in arrears.

21. The computer program product of claim 20, wherein the fourth set of codes is further configured to cause the computer to determine the work assignment queues in response to determining the segment of the enterprise business responsible for attempting payment recovery for each of the plurality of financial accounts currently in arrears.

22. The computer program product of claim 19, further comprising a fourth set of codes for causing a computer to determine, based on applying the (1) financial institution account metrics and (2) the customer attributes to business-defined payment recovery channel rules, a payment recovery channel for attempting payment recovery for each of the plurality of financial accounts currently in arrears.

23. The computer program product of claim 22, wherein the third set of codes is further configured to cause the computer to determine, based on applying (1) the financial institution account metrics and (2) customer attributes associated with the customers to business-defined segmentation rules, the segment, wherein the business-defined segmentation rules provide for determining the segment of the enterprise business that maximizes profitability in terms of payment recovery.

24. The computer program product of claim 19, further comprising a fourth set of codes for causing a computer to determine based on applying account collection history data to payment recovery velocity rules, a next allowable date for attempting payment recovery from each of the financial accounts currently in arrears.
